(19) United States
(12) Patent Application Publication
(10) Pub. No.: US 2007/0142954 A1
(43) Pub. Date: Jun. 21, 2007

(54) Method and apparatus for automated processing by upfront specification of process parameters

(75) Inventors: Johnny H. Wu, Portland, OR (US); Bo Li, Portland, OR (US); Aishwarya Varadhan, Portland, OR (US); Murali Krishna, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Intel Corporation

(21) Appl. No.: 11/315,832

(22) Filed: Dec. 21, 2005

(51) Int. Cl. G06F 19/00

(52) U.S. Cl. 700/116; 700/97

(57) ABSTRACT

In one embodiment, a method for upfront specification of lot process parameters to enable automated processing is disclosed. The method comprises specifying a combination of one or more process parameters in a template associated with a tool, the process parameters associated with a process flow for a lot to be processed by the tool, and subsequent to the specifying, automatically retrieving by the tool the specified combination of process parameters at least one of when the lot arrives at the tool for processing, during processing of the lot by the tool, and after processing of the lot by the tool, wherein automatically retrieving includes retrieving the specified combination without human intervention. Other embodiments are also described.

### FIELD OF THE INVENTION

The embodiments of the invention relate generally to the field of semiconductor processing and, more specifically, relate to a mechanism for upfront specification of lot process parameters to enable automated processing.

### BACKGROUND

In a semiconductor processing line, wafer process tool idle time is a problem that exists due to delays in waiting for a tool operator to provide required input of lot process parameters to a tool. This wafer process tool idle time is a roadblock to automated, uninterrupted processing of material. Interruption of automated lot processing results in longer process cycle times, and thus, overall throughput delays for semiconductor manufacturing.

Currently, tool operators manually specify lot process information at the time that a tool is ready to process a lot. This specification is performed at a user interface (UI) on the semiconductor process tool itself, or at a UI communicating to the semiconductor tool via a standard communication protocol. Although selection of material and delivery of material to the tool can be automated, the tool will pause and request information from a user as needed in order to initiate or complete processing.

For example, the typical routine that occurs at a tool on a semiconductor processing line includes the following steps: (1) A lot is selected to be processed on the particular tool; (2) The lot is delivered to the tool; (3) The tool Station Controller (SC) displays a window on a UI requesting input from a tool operator (e.g., an engineering technician) for a particular process parameter; (4) The tool operator (using a keyboard) types in the required process parameter on the UI; (5) The SC performs some validation of the parameter (if invalid or incorrect, the SC will repeat step 3); (6) If accepted, the SC proceeds with the processing of the lot on the tool; (7) Steps 3-6 are repeated several times for each processing parameter required by the tool. Furthermore, process parameters may be requested any time before, during, or after processing of the lot, creating many interruptions to the process flow.

A typical routine, such as the one described above, requires factory technicians to spend, on the average, 5-30 minutes typing in the parameters for each lot processing when they are prompted to do so. If the technician is busy with this task on one tool, then other tools could be idle or waiting for the technician to input processing parameters before the tool can continue processing their lots.

The above routine is problematic because it creates needless idle time as the tool is delayed from processing until a user manually enters the required process parameters. Presently, there is no ability to provide in an automated fashion the correct process parameters to the tool that are specific to the lot, the operation to be processed, and the tool type.

### BRIEF DESCRIPTION OF THE DRAWINGS

The invention will be understood more fully from the detailed description given below and from the accompanying drawings of various embodiments of the invention. The drawings, however, should not be taken to limit the invention to the specific embodiments, but are for explanation and understanding only.

FIG. 1 illustrates a block diagram of a semiconductor manufacturing system according to embodiments of the invention;

FIG. 2 illustrates a table depicting a template of one embodiment of the invention;

FIG. 3 illustrates a table defining fields of a template according to embodiments of the invention;

FIG. 4 is a flow diagram of a method of one embodiment of the invention;

FIG. 5 is a flow diagram of a method of another embodiment of the invention; and

FIG. 6 illustrates a block diagram of one embodiment of a computer system.

### DETAILED DESCRIPTION

A method and apparatus for upfront specification of lot process parameters to enable automated processing are described. In the following detailed description of the present invention, numerous specific details are set forth in order to provide a thorough understanding of the present invention. However, it will be apparent to one skilled in the art that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Embodiments of the present invention provide a mechanism for upfront specification of lot process parameters (LPP) to enable automated processing of lots at tools in a semiconductor manufacturing line. In one embodiment, a lot is a collection of up to, e.g., twenty-five wafers that are grouped together for processing and transport. In one embodiment, process parameters are information specific to a tool and an operation that guides the processing of the lot on the tool for the given operation. Accordingly, LPPs are process parameters that are assigned to a particular lot. In one embodiment, automated processing may refer to any processing that is done without concurrent human interaction.

By enabling automated and non-interrupted lot processing, tool idle time may be reduced. Embodiments of the invention eliminate the need for tool operators to manually provide lot process information to the tool both at the time the tool is ready to process material and during the time the tool is processing material.

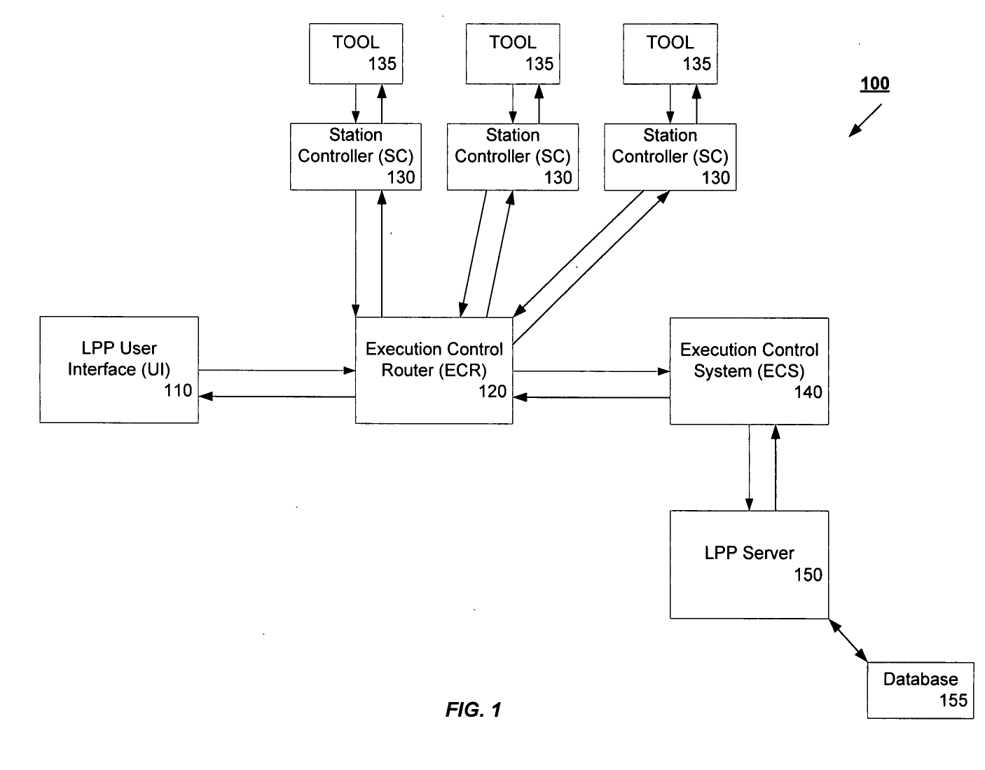

FIG. 1 is a block diagram of one embodiment of a semiconductor manufacturing system 100. The semiconductor manufacturing system 100 includes an execution control system (ECS) 140, an execution control router (ECR) 120, a plurality of station controllers (SC) 130, an LPP user interface (UI) 110, an LPP server 150, and a database 155.

The ECS 140 is a central coordination system for the semiconductor manufacturing system 100. For example, ECS 140 provides information relating to real-time work-in-progress inventory in the factory, tool cycle time distribution profiles, and real-time automated material handling system equipment location and status (including storage machine utilization). ECR 120 routes information between the ECS 140 and its associated tools 135 and SCs 130. ECR 120 also routes information to a LPP UI 100 that is provided to users of the semiconductor manufacturing system 100. In one embodiment, a UI is an interface presented to a tool operator for entering data related to a tool and/or a lot. U's may include, for example, the LPP U's and SC U's

SCs 130 are computer systems that control the operations of their respective tools 135. In one embodiment, an operation is a specific step of a processing flow where a lot requests a service from a service provider (such as a processing tool). In one embodiment, the SC is a host controller computer of a manufacturing tool. Standard functions of a SC may include updating a manufacturing execution system (MES) for the semiconductor manufacturing line on the state of a lot and a tool, downloading process recipes to be run at the tool, and collecting process data from the tool. Tools 135, which are controlled by SC 130, perform operations on lots traveling through the semiconductor manufacturing line to the tools 135.

The LPP server 150 manages information associated with the process plans for the various lots being processed by the semiconductor manufacturing system 100. In one embodiment, a process plan includes a collection of operations that describe the flow of the lot through the factory. The LPP server 150 further includes a database 155 to store LPPs associated with particular operations and/or lots. In some embodiments, there are a multitude of tools 135 and associated SCs 130 for these tools, all communicatively coupled to ECS 140 via ECR 120.

The components of semiconductor manufacturing system 100 operate together to provide upfront specification of LPPs to enable automated processing of lots on various tools in a semiconductor manufacturing line. This automated processing of lots eliminates the need for manual intervention to input LPPs before, during, and after lot processing. With embodiments of the invention, lot processing at tool 135 is streamlined because tool 135 directly acquires the LPPs from the ECS 140, instead of through manual input. Hence, tool 135 may run in an unattended and continuous mode.

In prior semiconductor manufacturing systems, the SC 130 included the customized lot processing model or logic. In one embodiment, customized may refer to having characteristics pertaining to all lots. Embodiments of the present invention provide the ability for ECS 140 to validate and consolidate LPP data from LPP server 150 before passing them to SC 130. The SC 130 lot processing model may then be modified by ECS 140 based on operational needs.

Furthermore, in prior semiconductor manufacturing systems, the LPPs were hard-coded into the SC 130. As a result, changes in the SC 130 for a new tool or product required one to two months of development and testing cycles. Embodiments of the present invention allow for LPP changes due to the introduction of new products or tools to be completed at least four times as quickly, for example in one to two weeks. In addition, the change implementation procedure is generic which results in an efficient and reliable system to support the operational changes in the semiconductor manufacturing line.

The automated lot processing of embodiments of the invention may be accomplished through a process including: (1) process parameter template construction, (2) upfront specification of LPPs via the process parameter template, and (3) automated delivery of the LPPs of a lot and operation to the tool upon process initiation. Each of these phases of providing automated lot processing is described in more detail below.

(1) Process Parameter Template Construction:

Before a lot is processed at any particular tool in the semiconductor manufacturing line, a template is constructed for each tool specifying the various parameters associated with operations performed by the tool. Embodiments of the invention provide for a flexible and configurable template for upfront specification of lot process information for a specific tool type. For each tool type in the semiconductor manufacturing line, a configurable template (specific to a tool type) may be created to customize the lot process parameters for each particular tool. This template provides a structured format for tool operators to specify the lot process information for the tool. In addition, new templates may be added to accommodate new tool types in the factory.

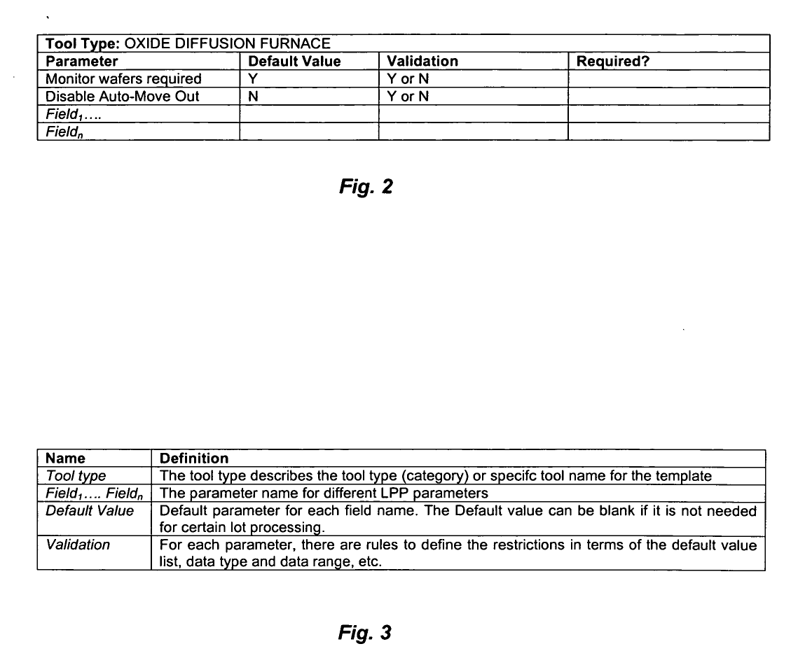

FIG. 2 is a table illustrating an embodiment of an exemplary template. As illustrated, the exemplary template is for a specific tool type. Similar templates may be created for each tool in the semiconductor manufacturing line. FIG. 3 is a table providing definitions for the various entries in an exemplary template, such as the template shown with respect to FIG. 2. The tool type describes the tool type or specific tool name for the template. In the case of FIG. 2, the tool is an Oxide Diffusion Furnace. Within each tool template, a parameter is provided for each of the various functions performed by the tool. Combinations of these parameters are later combined to form a specific operation of the tool.

Various parameters, or fields such as Field₁ . . . . Fieldₙ, are defined for the tool based on the operational needs of the tool. Some examples of generic lot process parameters include monitor wafers required, disable move-out, recipe override, introduction type, tool override, and comments. Two generic parameters are shown in FIG. 2. Some examples of tool-specific lot process parameters include specification of individual wafer slots and number of empty carriers required. In one embodiment, the parameters in the template are easily modified and expanded to accommodate future information that may be needed by the tool. One skilled in the art will appreciate that various other parameters for a tool may be defined.

For each of the parameters, default LPP values may be specified. The field name definition may be added or modified for a particular lot or operation. Furthermore, there may be validation rules specified for different fields to restrict the field value, data type, etc. The validation rules may enforce specific values or specify restrictions for a parameter in terms of its defaults values, data types, and data ranges.

(2) Up-front Specification of Process Parameters for the Process Flow of a Lot:

In one embodiment, once the process parameter templates have been constructed for each tool in the semiconductor manufacturing line, up-front specification of specific process parameters for the process flow of a lot may be performed. This up-front specification also occurs at a time prior to the processing of a lot.

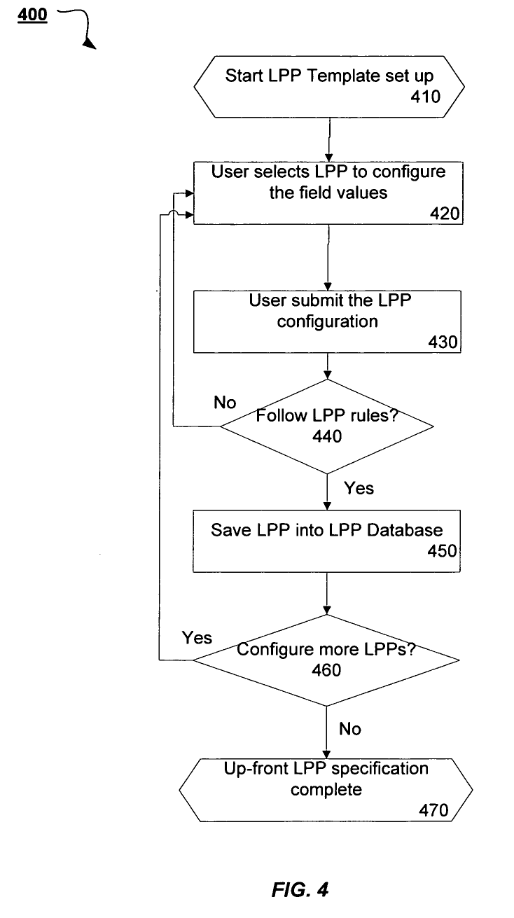

FIG. 4 is a flow diagram illustrating one embodiment of a process for up-front specification of LPPs for a lot. In some embodiments, process 400 is performed by the semiconductor manufacturing system 100 described with respect to FIG. 1. As part of process 400, a user (e.g., engineer, tool operator, or manufacturing technician) may interact with a UI to retrieve a lot process plan for a given lot.

At processing block 410, the user specifies a lot number in the UI and then a pre-defined process plan for the lot appears on the UI. Any correlated process parameter default values are shown for each operation on the process plan at this time. At processing blocks 420 and 430, the user may choose to modify one of the particular operations performed by the tool. The tool-specific template for the tool-type associated with the operation, including any related operation parameters, appears on the UI. The user may then modify or add on the template all required process information for the operation on the tool.

Then, at decision block 440, the system validates the information and alerts the user if the provided input is invalid, numerically out-of-bounds, or not allowed by the specific LPP template rule. In one embodiment, validation refers to a comparison between the provided input and restrictions that may have been previously placed on the input. For example, a parameter may be limited to a value of yes or no. If a provided input is a value other than these restricted values, then upon validation this provided input will not be allowed. This validation may be performed by the ECS and be based on rules that specify the restrictions for a parameter in terms of its defaults values, data types, and data ranges.

If the validation is not successful, the process returns to processing block 420 where the user may modify the field values. In one embodiment, successful validation may include when all parameters have not violated any rules or restrictions placed on the parameters. In other embodiments, successful validation may include when only those parameters defined as key parameters have not violated and rules or restrictions place on the parameters.

If the validation is successful, then, at processing block 450, the process parameters for the specified lot are saved for the particular operation at the LPP database. At decision block 460, it is determined whether any other LPPs are to be configured. If so, additional LPPs may be configured for multiple operations along the process plan for the lot by returning to processing block 420. Otherwise, the up-front specification of the LPPs is complete at processing block 470.

Embodiments of the invention also allow tool operators to provide common lot process parameters using the template and correlate these values to any combination of a specific lot, a specific route, or a specific operation. In one embodiment, a route is a collection of operations that describes a segment of the process plan of the lot. In order to reduce redundant data entry, common process parameters may be correlated to different process structures. This correlation is stored throughout the manufacturing system so that all lots utilize the correlation. In some embodiments, correlation may be stored in the following prioritized hierarchy (from most specific to most generic):
Process parameters correlated to a specific lot, a specific operation (semiconductor process operation), and a specific route (a collection of operations that describes a segment of the process flow the lot)
Process parameters correlated to a specific lot and a specific operation
Process parameters correlated to a specific operation on a route
Process parameters correlated to a specific operation
Specific individual process parameters correlated to a specific route

Embodiments of the invention further allow tool operators to view and adjust correlated process parameters for multiple downstream operations, possibly including the complete process plan for the lot. Process parameters for each operation will be automatically populated based on the correlation hierarchy. Furthermore, tool operators may add or override process parameters using the template specific to the tool-type for a particular operation on the process plan. Process parameters will be validated according to the validation rules specified by template in order to reduce or eliminate operator error. Default or correlated values will be used for process parameters that are not specified.

Embodiments of the invention further provide for the persistence of the specified lot process information so that it may be leveraged for factory scheduling and other algorithms for automated selection of lots and tools for processing. The existence of upfront lot process information is a distinct technical advantage for automated execution control and factory scheduling over the state-of-art.

(3) Provide LPPs for Tool When Process Initiated:

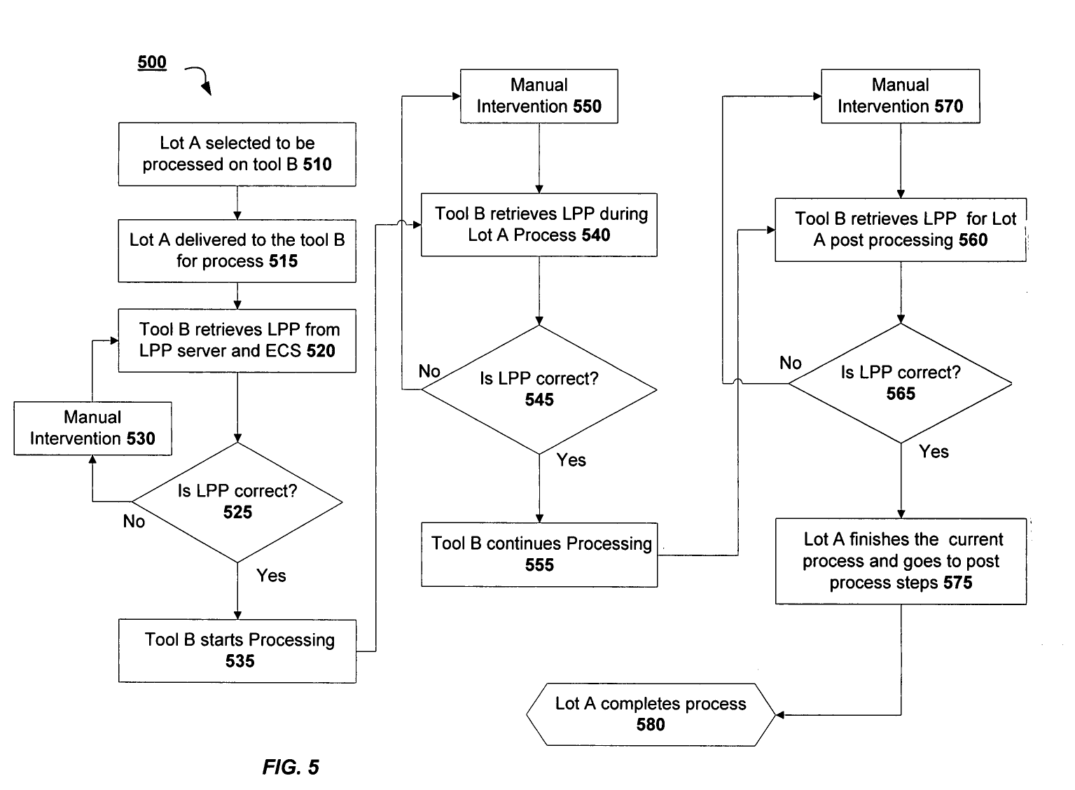

FIG. 5 is a flow diagram illustrating on embodiment of a process 500 for providing LPPs to a tool when an operation is initiated for a particular lot at the tool. At processing block 510, a lot (e.g., lot A) is selected to be processed on a particular tool (e.g., tool B). Then, at processing block 515, the lot is delivered to the tool. At processing block 520, the tool automatically retrieves the LPP from the LPP server and the ECS. In some embodiments, the tool SC requests the LPPs for the given lot from the ECS. This may include LPPs for a variety of operations on the particular tool. It may also include a special LPP for the lot if the particular lot requires special parameters in its operations. The lot and current operation is provided to the ECS from the tool, and then the ECS retrieves the LPPs from the LPP Server.

At decision block 525, it is determined whether the LPP is correct for the particular operation and lot. In one embodiment, the ECS includes the lot processing model and policy in LPP evaluation logic. The ECS responds to the SC with the appropriate lot process parameters based on the LPP setup and policy specified for the lot processing. If errors are encountered at this point, manual intervention occurs at processing block 530. The manual intervention is an exception handling procedure for those cases where the LPPs are not correct at the point in time a lot reaches the tool. In these cases, a user may intervene to correct the parameters.

At processing block 535, the SC begins processing the lot on the tool. The process of automatically retrieving the LPP, determining if the LPP is correct, manually intervening if there are errors, and continuing processing in process blocks 520-535 are similarly repeated for the time periods during and after processing at processing blocks 550-575. When processing is completed and all parameters are verified, the lot completes processing at the tool at process block 580.

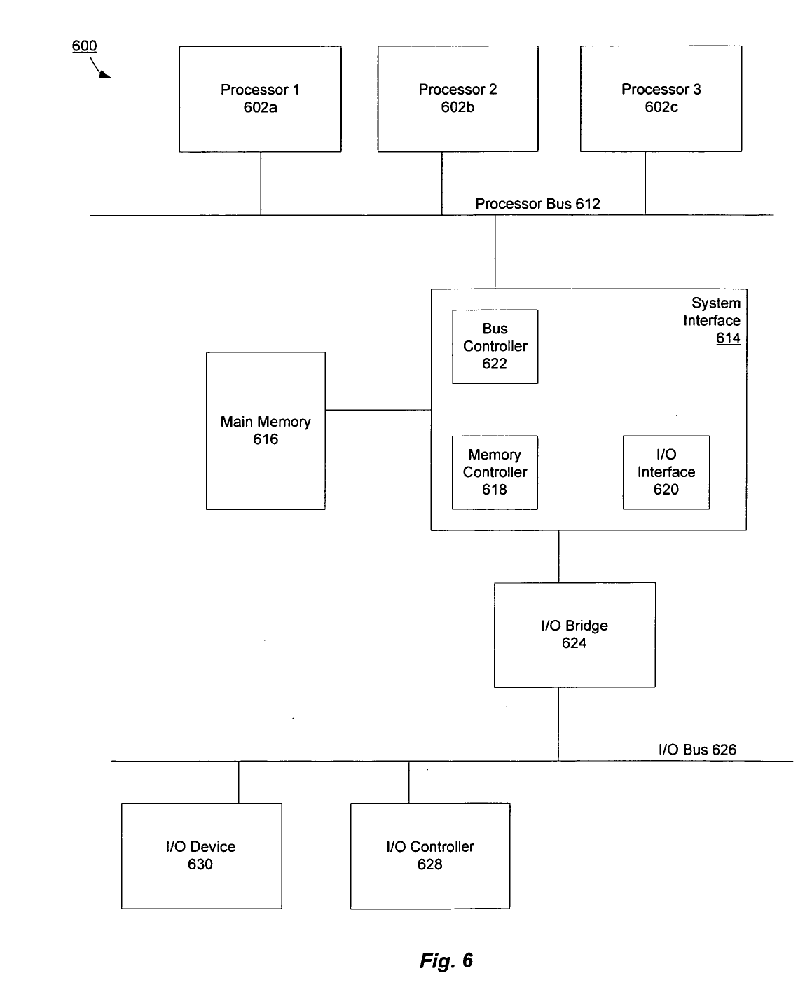

FIG. 6 is a block diagram illustrating an exemplary computer system 600 used in implementing one or more embodiments of the invention. The computer system (system) 600 includes one or more processors 602a-c. The processors 602a-c may include one or more single-threaded or multi-threaded processors. A typical multi-threaded processor may include multiple threads or logical processors, and may be capable of processing multiple instruction sequences concurrently using its multiple threads.

Processors 602a-c may also include one or more internal levels of cache and a bus controller or bus interface unit to direct interaction with the processor bus 612. As in the case of chip multiprocessors or multi-core processors, processors 602a-c may be on the same chip. The chip may include shared caches, interprocessor connection networks, and special hardware support such as those for SPT execution (not shown). Furthermore, processors 602a-c may include multiple processor cores. Processor bus 612, also known as the host bus or the front side bus, may be used to couple the processors 602a-c with the system interface 614.

System interface 614 (or chipset) may be connected to the processor bus 612 to interface other components of the system 600 with the processor bus 612. For example, system interface 614 may include a memory controller 618 for interfacing a main memory 616 with the processor bus 612. The main memory 616 typically includes one or more memory cards and a control circuit (not shown). System interface 614 may also include an input/output (I/O) interface 620 to interface one or more I/O bridges or I/O devices with the processor bus 612. For example, as illustrated, the I/O interface 620 may interface an I/O bridge 624 with the processor bus 612. I/O bridge 624 may operate as a bus bridge to interface between the system interface 614 and an I/O bus 626. One or more I/O controllers and/or I/O devices may be connected with the I/O bus 626, such as I/O controller 628 and I/O device 630, as illustrated. I/O bus 626 may include a peripheral component interconnect (PCI) bus or other type of I/O bus.

System 600 may include a dynamic storage device, referred to as main memory 616, or a random access memory (RAM) or other devices coupled to the processor bus 612 for storing information and instructions to be executed by the processors 602a-c. Main memory 616 may also be used for storing temporary variables or other intermediate information during execution of instructions by the processors 602a-c. System 600 may include a read only memory (ROM) and/or other static storage device coupled to the processor bus 612 for storing static information and instructions for the processors 602a-c.

Main memory 616 or dynamic storage device may include a magnetic disk or an optical disc for storing information and instructions. I/O device 630 may include a display device (not shown), such as a cathode ray tube (CRT) or liquid crystal display (LCD), for displaying information to an end user. I/O device 630 may also include an input device (not shown), such as an alphanumeric input device, including alphanumeric and other keys for communicating information and/or command selections to the processors 602a-c. Another type of user input device includes cursor control, such as a mouse, a trackball, or cursor direction keys for communicating direction information and command selections to the processors 602a-c and for controlling cursor movement on the display device.

System 600 may also include a communication device (not shown), such as a modem, a network interface card, or other well-known interface devices, such as those used for coupling to Ethernet, token ring, or other types of physical attachment for purposes of providing a communication link to support a local or wide area network, for example. Stated differently, the system 600 may be coupled with a number of clients and/or servers via a conventional network infrastructure, such as a company's intranet and/or the Internet, for example.

It is appreciated that a lesser or more equipped system than the example described above may be desirable for certain implementations. Therefore, the configuration of system 600 may vary from implementation to implementation depending upon numerous factors, such as price constraints, performance requirements, technological improvements, and/or other circumstances.

It should be noted that, while the embodiments described herein may be performed under the control of a programmed processor, such as processors 602a-c, in alternative embodiments, the embodiments may be fully or partially implemented by any programmable or hardcoded logic, such as field programmable gate arrays (FPGAs), transistor transistor logic (TTL) logic, or application specific integrated circuits (ASICs). Additionally, the embodiments of the invention may be performed by any combination of programmed general-purpose computer components and/or custom hardware components. Therefore, nothing disclosed herein should be construed as limiting the various embodiments of the invention to a particular embodiment wherein the recited embodiments may be performed by a specific combination of hardware components.

In the above description, numerous specific details such as logic implementations, opcodes, resource partitioning, resource sharing, and resource duplication implementations, types and interrelationships of system components, and logic partitioning/integration choices may be set forth in order to provide a more thorough understanding of various embodiments of the invention. It will be appreciated, however, to one skilled in the art that the embodiments of the invention may be practiced without such specific details, based on the disclosure provided. In other instances, control structures, gate level circuits and full software instruction sequences have not been shown in detail in order not to obscure the invention. Those of ordinary skill in the art, with the included descriptions, will be able to implement appropriate functionality without undue experimentation.

The various embodiments of the invention set forth above may be performed by hardware components or may be embodied in machine-executable instructions, which may be used to cause a general-purpose or special-purpose processor or a machine or logic circuits programmed with the instructions to perform the various embodiments. Alternatively, the various embodiments may be performed by a combination of hardware and software.

Various embodiments of the invention may be provided as a computer program product, which may include a machine-readable medium having stored thereon instructions, which may be used to program a computer (or other electronic devices) to perform a process according to various embodiments of the invention. The machine-readable medium may include, but is not limited to, floppy diskette, optical disk, compact disk-read-only memory (CD-ROM), magneto-optical disk, read-only memory (ROM) random access memory (RAM), erasable programmable read-only memory (EPROM), electrically erasable programmable read-only memory (EEPROM), magnetic or optical card, flash memory, or another type of media/machine-readable medium suitable for storing electronic instructions. Moreover, various embodiments of the invention may also be downloaded as a computer program product, wherein the program may be transferred from a remote computer to a requesting computer by way of data signals embodied in a carrier wave or other propagation medium via a communication link (e.g., a modem or network connection).

Similarly, it should be appreciated that in the foregoing description, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as the invention.

What is claimed is:

1. A method, comprising:
specifying a combination of one or more process parameters in a template associated with a tool, the process parameters associated with a process flow for a lot to be processed by the tool; and
subsequent to the specifying, automatically retrieving by the tool the specified combination of process parameters at least one of when the lot arrives at the tool for processing, during processing of the lot by the tool, and after processing of the lot by the tool;
wherein automatically retrieving includes retrieving the specified combination without human intervention.

2. The method of claim 1, wherein the specified process parameters are correlated to an operation performed by the tool.

3. The method of claim 2, wherein the specified process parameters for the operation are persisted as default values for lots processed with the operation.

4. The method of claim 1, wherein the specified process parameters are correlated to a route of the lot, wherein the route is a collection of operations that encompass a segment of the process flow of the lot.

5. The method of claim 1, wherein default values for the process parameters are specified in the template, the default values used as values for the process parameters that are not specified.

6. The method of claim 1, wherein the template includes validation information to enforce specific values and restrictions of the process parameters.

7. The method of claim 6, wherein an exception handling routine is invoked if the validation information indicates an error of the specified processing parameters, the exception handling routine to allow for manual intervention of processing of the lot.

8. The method of claim 1, wherein the method is practiced on two or more tools concurrently.

9. A semiconductor manufacturing system, comprising:
a control system;
a lot process parameter user interface provided by the control system to enable specification of a combination of one or more process parameters in a template associated with a tool, the process parameters associated with a process flow for a lot to be processed by the tool; and
a station controller to automatically retrieve without human intervention through the control system the specified combination of process parameters at least one of when the lot arrives at the tool for processing, during processing of the lot at the tool, and after processing of the loot at the tool.

10. The system of claim 9, wherein the control system includes a lot process parameter server having a database to store the template and the specified combination of process parameters for the lot.

11. The system of claim 9, wherein the specified process parameters are correlated to an operation performed by the tool.

12. The system of claim 9, wherein the specified process parameters are correlated to a route of the lot, wherein the route is a collection of operations that encompass a segment of the process flow of the lot.

13. The system of claim 9, wherein default values for the process parameters are specified in the template, the default values used for the process parameters that are not specified.

14. The system of claim 9, wherein the system operates on two or more tools concurrently.

15. The system of claim 9, further comprising a template user interface provided by the control system to construct the template for the tool, the template including process parameters associated with the tool.

16. A machine-accessible medium having stored thereon data representing sets of instructions that, when executed by a machine, cause the machine to perform operations comprising:
constructing a template for a tool of a semiconductor manufacturing system, the template including process parameters associated with the tool;
specifying a combination of one or more of the process parameters from the template that are associated with a process flow for a lot, the lot to be processed by the tool; and
subsequent to the specifying, automatically retrieving by the tool the specified combination of process parameters at least one of when the lot arrives at the tool for processing, during processing of the lot by the tool, and after processing of the lot by the tool;
wherein automatically retrieving includes retrieving the specified combination without human intervention.

17. The machine-accessible medium of claim 16, wherein the specified process parameters are correlated for an operation performed by the tool.

18. The machine-accessible medium of claim 16, wherein the specified process parameters are correlated to a route of the lot, wherein the route is a collection of operations that encompass a segment of the process flow of the lot.

19. The machine-accessible medium of claim 16, wherein an exception handling routine is invoked if the validation information indicates an error at the specified process parameters, the exception handling routine to allow for manual intervention of processing of the lot.

20. The machine-accessible medium of claim 16, wherein the instructions cause the machine to perform the operations on two or more tools concurrently.
